(19) United States
(12) Patent Application Publication
(10) Pub. No.: US 2021/0309043 A1
(43) Pub. Date: Oct. 7, 2021

(54) DEVICE FOR DIVIDING AN ANGLE INTO A PLURALITY OF SMALLER EQUAL ANGLES

(71) Applicant: Lewis Dynamic Geometry Pty Ltd, Sydney (AU)

(72) Inventor: John Trevor Lewis, Wolli Creek (AU)

(21) Appl. No.: 17/338,861

(22) Filed: Jun. 4, 2021

Related U.S. Application Data
(63) Continuation of application No. PCT/AU2019/051323, filed on Dec. 4, 2019.

(30) Foreign Application Priority Data
Dec. 4, 2018 (AU) 2018904595

(51) Int. Cl. B43L 13/00

(52) U.S. Cl. CPC B43L 13/002

(57) ABSTRACT

A device for dividing an angle into a plurality of smaller equal angles, comprising: a lower translucent sheet; and an upper translucent sheet positioned over the lower translucent sheet and pivotally connected to the lower translucent sheet at a pivot point for alignment to a vertex of the angle, to enable the upper translucent sheet to rotate relative to the lower translucent sheet; wherein the translucent sheets are marked with visual indicia corresponding to: a straight arm line for alignment on an arm of the angle; and a plurality of progressive loci curves using a T-tool defined by a straight line (EF) of a fixed length between two points (E, F) that is bisected by a bisecting straight line (B) at 90 degrees.

### CROSS-REFERENCE TO RELATED APPLICATIONS

This application is a continuation of International Patent Application No. PCT/AU2019/051323, filed Dec. 4, 2019, which claims priority to Australian Patent Application No. 2018904595, filed Dec. 4, 2018, the entire contents of each of which are incorporated herein by reference.

### FIELD OF THE INVENTION

The present invention relates to a device for dividing an angle into a plurality of smaller equal angles

### BACKGROUND TO THE INVENTION

Bisection and multiple bisections (2, 4, 8, 16, etc) of an angle is considered possible using conventional mechanical tools and mechanical devices.

It is mathematically impossible to trisect an angle using a straightedge e.g. a ruler, and a compass.

Many prior attempts at trisecting an angle have been proposed. These include Archimedes' method of angle trisection and also the use of a curve called the Quadratrix of Hippias. However both these methods are time-consuming and require multiple lines to be drawn carefully in a sequential step wise manner.

U.S. Pat. No. 2,208,137 discloses an angle dividing instrument having two side arms pivoted together at one end, an upright member mounted adjacent the pivot point of the two side arms.

U.S. Pat. No. 3,906,638 discloses an angle divider comprising a plurality of blades. There are an equal number of graduations from the center of each blade determining equal angular segments of an angle whose legs coincide with an equal number of graduations at the outer side of the centers of the two outermost blades of said plurality of blades.

The prior mechanical devices and instruments for dividing an angle are fiddly and take considerable time simply to trisect an angle, and no known prior mechanical devices and instruments for dividing an angle into three or more equal smaller angles.

### SUMMARY OF THE INVENTION

The inventive concept arises from a recognition that it is desirable to divide an angle (e.g. bisect or trisect) into equal smaller angles using a device of a simple mechanical structure, that is inexpensive in manufacture, is simple and convenient to use, and functions efficiently, effectively and reliably to divide an angle into smaller equal angles. Such a device has a very useful benefit for mathematics students, architects, engineers, designers and surveyors.

The present invention, in one aspect, is a device for dividing an angle into a plurality of smaller equal angles, comprising: a lower translucent sheet. The device also comprises an upper translucent sheet positioned over the lower translucent sheet and pivotally connected to the lower translucent sheet at a pivot point for alignment to a vertex of the angle, to enable the upper translucent sheet to rotate relative to the lower translucent sheet. The translucent sheets are marked with visual indicia corresponding to: a straight arm line for alignment on an arm of the angle; and a plurality of progressive loci curves using a T-tool defined by a straight line (EF) of a fixed length between two points (E, F) that is bisected by a bisecting straight line (B) at 90 degrees, each loci curve is formed by marking a point corresponding to a position at point E of the T-tool when the bisecting straight line (B) passes through the vertex of the angle, and point F of the T-tool is initially positioned on the straight arm line or positioned on a previous point E of the T-tool for a previous loci curve.

The translucent sheets may further comprise visual indicia corresponding to a plurality of arcs having a centre corresponding to the pivot point.

The translucent sheets may further comprise visual indicia corresponding to a plurality of asymptote areas, each asymptote area having the same height corresponding to the fixed length of the straight line (EF) and arranged parallel to the straight arm line.

The sheets may be transparent.

The sheets may be made from a flexible or rigid material.

The sheets may comprise holes or slots to permit a writing instrument to mark a writing medium depicting the angle, positioned beneath the lower translucent sheet.

Each asymptote area may be a different colour, shading or pattern, and the asymptote areas of both sheets are the same.

In a second aspect, there is provided a method for dividing an angle into n number of smaller equal angles using the device as described. The method comprises positioning the lower translucent sheet such that the straight arm line of the lower translucent sheet is aligned with a first arm of the angle. The method also comprises positioning the upper translucent sheet such that the straight arm line of the upper translucent sheet is aligned with a second arm of the angle. The method also comprises positioning the pivot point over the vertex of the angle. n number of quadrilateral areas are defined by intersections of loci curves of the upper translucent sheet with loci curves on the lower translucent sheet between the straight arms lines of the translucent sheets, and n−1 intersection points of the intersecting loci curves of the n number of quadrilateral areas distal to the pivot point are marked.

The method may further comprise drawing angle dividing straight lines between the vertex of the angle and the marked n−1 intersection points.

The loci related to the T-tool after placement in an angle reveals and visually indicates many divisions of the angle. If the angle is small, a smaller sized T-tool can show smaller loci curves.

Other advantages and features according to the invention will be apparent to those of ordinary skill upon reading this specification as a whole.

Illustrative, non-exhaustive embodiments of the invention will be described below with reference to the accompanying drawings in which like reference numbers denote like elements.

### BRIEF DESCRIPTION OF THE DRAWINGS

FIG. 1 is a photo of a device for dividing an angle into a plurality of smaller equal angles depicting its two sheets rotated relative to each other at 90 degrees;

FIG. 2 is a photo of the device of FIG. 1 where the two sheets are rotated relative to each other at first position for an angle smaller than 90 degrees;

FIG. 3 is a photo of the device of FIG. 1 where the two sheets are rotated relative to each other at second position for a dividing a 60 degree angle;

FIG. 4 is a depiction of how a T-tool generates loci curves for the device;

FIG. 5 is diagram depicting two sheets of the device when in a separated form;

FIG. 6 is a sheet of the device showing marked numerals corresponding to each loci curve and a plurality of arcs with different radii;

FIG. 7 is a sheet of another embodiment of the device where the loci curves are spaced further apart than the device of FIG. 1;

FIG. 8 is yet another embodiment of the device where circular shaped sheets are used instead of rectangular sheets;

FIG. 9 is a depiction of a T-tool used to generate the loci curves of the device;

FIG. 10 is a sheet of the device depicting loci curves, asymptotes and asymptote areas and the relationship of T-tools generating the loci curves; and

FIG. 11 is a series of examples depicting the bisection, trisection or quinta-section of an angle UVW using a T-tool.

### DETAILED DESCRIPTION OF THE INVENTION

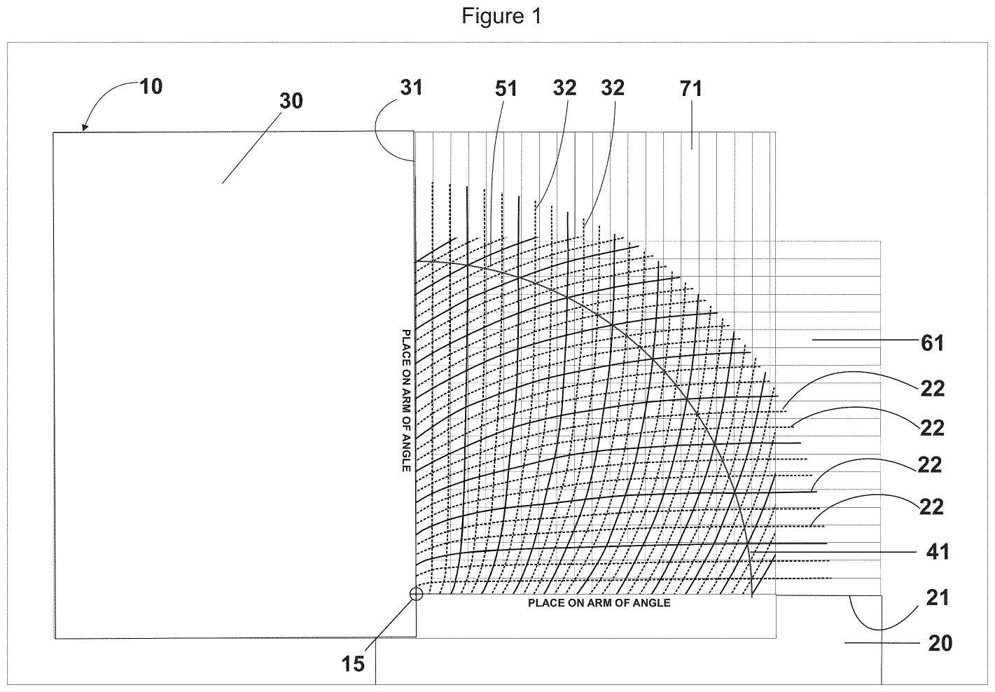

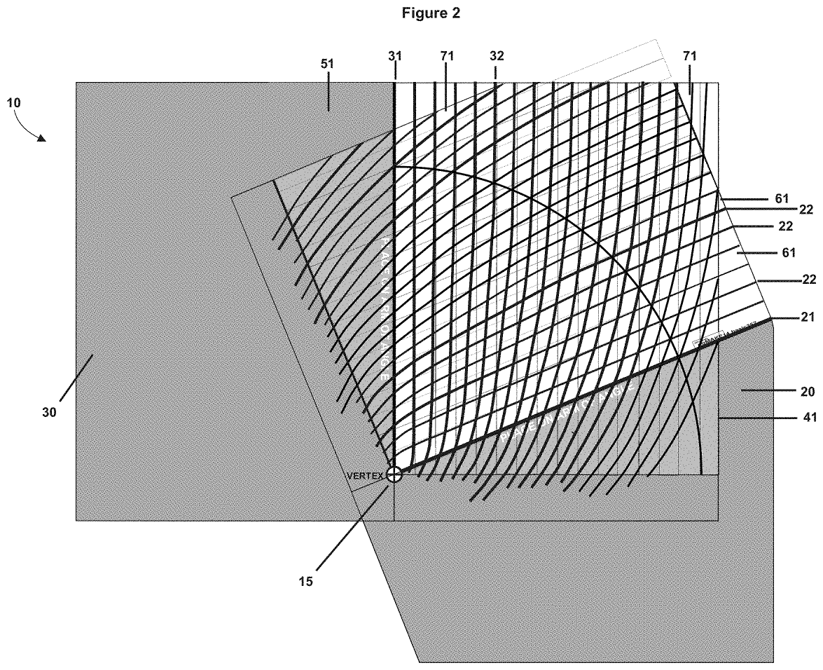

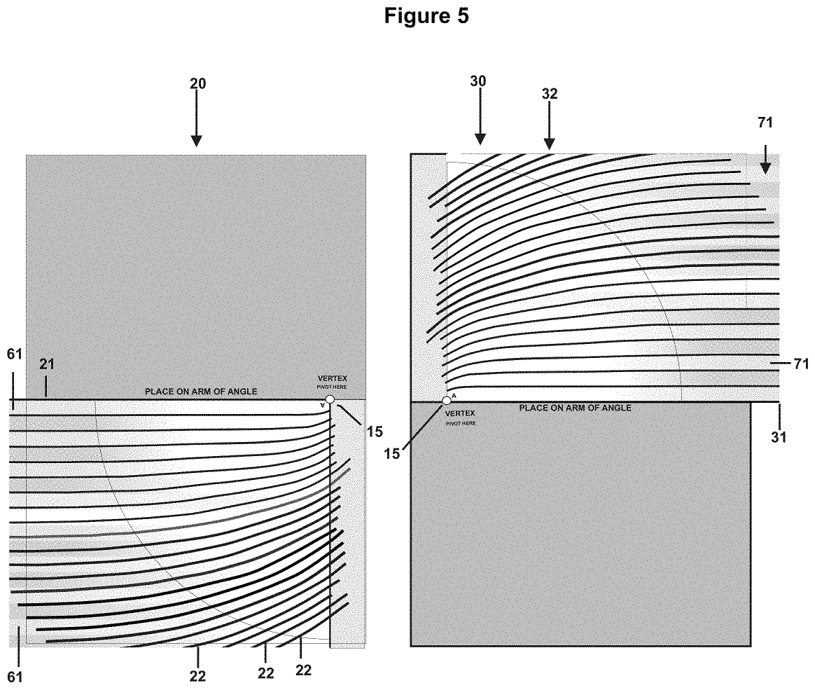

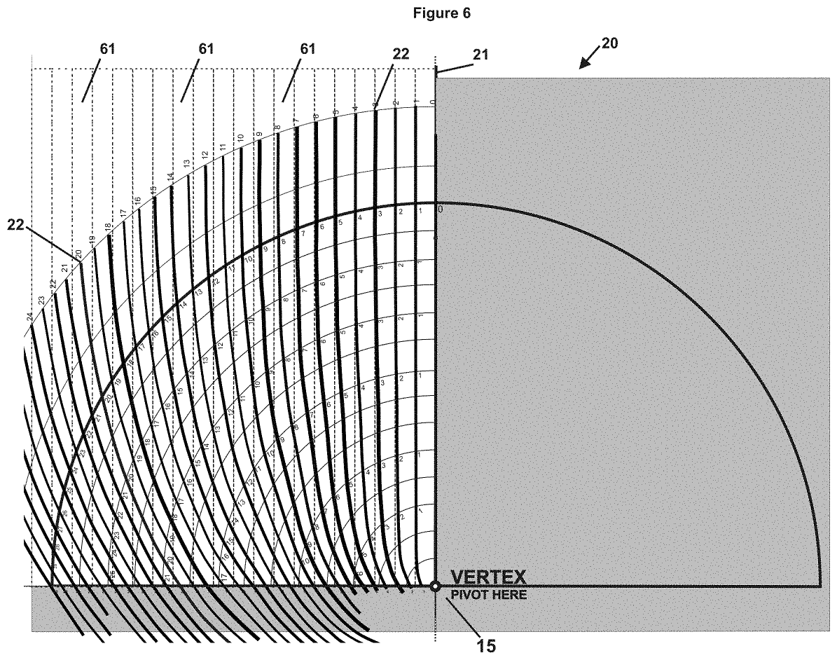

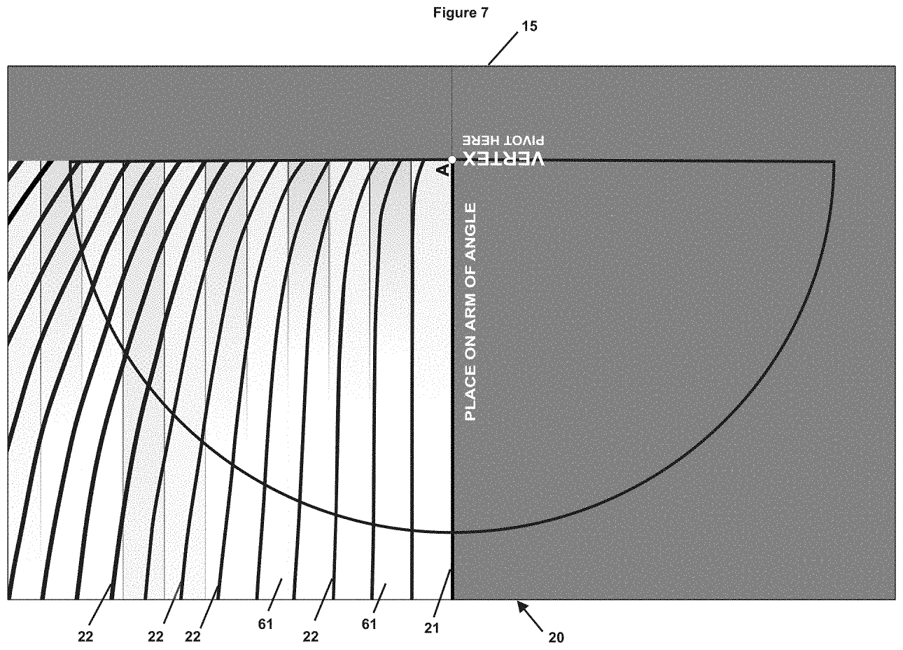

A preferred device for dividing an angle into a plurality of n smaller equal angles according to the present invention is illustrated in FIGS. 1 to 3, and 5 to 7 and shown generally at reference numeral 10. The number of smaller equal angles may be denoted n, where n is a positive integer. The device 10 comprises a lower translucent sheet 20. The device 10 also comprises an upper translucent sheet 30 positioned over and rotatable relative to the lower translucent sheet 20. The upper translucent sheet 30 is pivotally connected to the lower translucent sheet 20 at a pivot point 15. The pivot point 15 is to be aligned to a vertex of the angle, in use. The pivotal connection enables the upper translucent sheet 30 to rotate relative to the lower translucent sheet 20 about the pivot point 15.

The translucent sheets 20, 30 are each marked with visual indicia corresponding to a straight arm line 21, 31 for alignment on respective arms of the angle.

The translucent sheets 20, 30 are marked with visual indicia corresponding to a plurality of progressive loci curves 22, 32 using a T-tool 90. The T-tool 90 is defined by a straight line (EF) 91 of a fixed length between two points (E, F). The straight line (EF) is bisected by a bisecting straight line (B) 92 at 90 degrees. Each loci curve 22 is formed by marking a point corresponding to a position at point E of the T-tool 90 when the bisecting straight line (B) passes through the vertex of the angle. Point F of the T-tool 90 is initially positioned on the straight arm line or positioned on a previous point E of the T-tool 90 for a previous loci curve 22.

The loci curves 22, 32 can be drawn out and progress to 360 degrees and imagined to extend out to infinity.

In another embodiment, the translucent sheets 20, 30 further comprise visual indicia corresponding to a plurality of arcs 41, 51 having a centre corresponding to the pivot point.

In another embodiment, the translucent sheets 20, 30 further comprise visual indicia corresponding to a plurality of asymptote areas 61, 71. Each asymptote area 61, 71 has the same height and is arranged parallel to the straight arm line 21, 31. The height of each asymptote area 61, 71 corresponds to the fixed length of the straight line (EF) of the T-tool 90.

In one embodiment, the sheets 20, 30 are transparent. If transparent, there is no shading or colour on the sheets 20, 30 except for printed text and line markings.

The sheets 20, 30 are made from a flexible or rigid material.

The sheets 20, 30 comprise holes or slots to permit a writing instrument to mark a writing medium depicting the angle. The writing medium, for example, paper, is positioned underneath the lower translucent sheet 20.

Each asymptote area 61, 71 may be a different colour, shading or pattern. When the asymptote areas 61, 71 of each sheet 20, 30 are overlapped with each other, a mixture of the different colours can produce a unique colour which is a useful visual aid and easily identifiable by a user and reduces cognitive load. The asymptote areas 61, 71 of both sheets 20, 30 are the same which enables them to align correctly, that is, the colouring and/or shading line up.

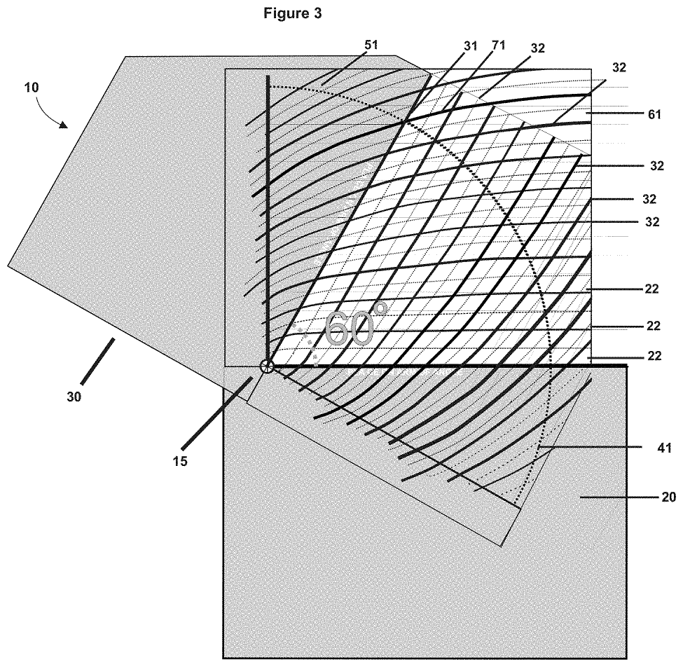

Turning to FIG. 3, in use, the method for dividing an angle into n number of smaller equal angles using the device 10 is as follows. The lower translucent sheet 20 is positioned such that the straight arm line 21 of the lower translucent sheet 20 is aligned with a first arm of the angle. The upper translucent sheet 30 is positioned such that the straight arm line 31 of the upper translucent sheet 30 is aligned with a second arm of the angle. The pivot point 15 is positioned over the vertex of the angle. The order or sequence of positioning the sheets 20, 30 and the pivot point 15 may be in any order.

n number of quadrilateral areas (e.g. diamond-shaped) are defined by intersections of loci curves 32 of the upper translucent sheet 30 with loci curves 22 on the lower translucent sheet 20 between the straight arms lines 21, 31 of the translucent sheets 20, 30. The n−1 intersection points of the intersecting loci curves 22, 32 of the n number of quadrilateral areas distal to the pivot point 15 are marked.

Angle dividing straight lines can be drawn between the vertex of the angle and the marked n−1 intersection points.

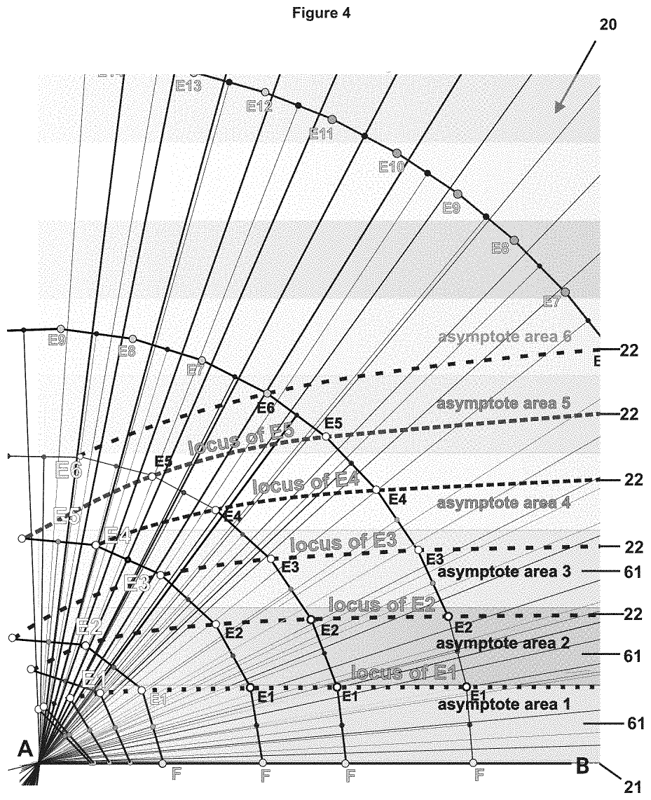

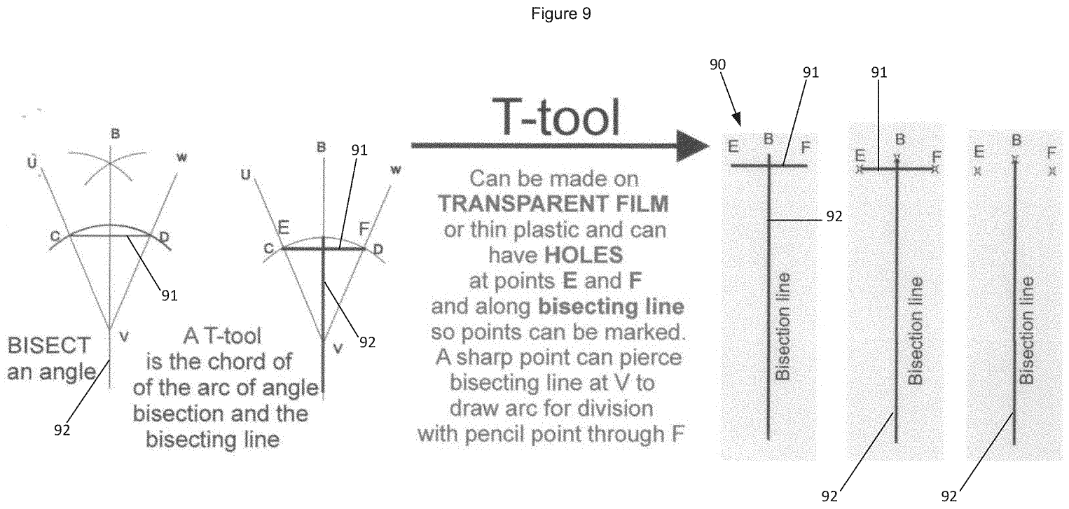

Referring to FIGS. 4 and 9, all T-tool 90s used to produce a device for angle division (other than bisection) must have the same length for the straight line 91 joining points E to F. As division progresses, it becomes clear than the first T-tool 90 can be imagined with its F point passing along and locked to VW of the angle UVW with its E point drawing out a loci or loci curve 22 that is independent to the angle UVW. Similarly the second T-tool 90, say E1 of the first T-tool 90 is aligned to point F2 of a second T-tool 90 and subsequent T-tool 90s: 3, 4, 5, etc aligned and each drawing of their loci curves 22 approaching their asymptotes that arise off line AB at infinity. Each loci curve 22 is separated by the length 91 of EF. A mirror image of the curves arise off the UV line.

The loci curves 22 can be drawn off a line AB where eventually A is the vertex of any angle and represents VW and its mirror image VU.

By drawing in a series of aligned T-tool 90s arising off line AB at some point, the loci curves 22 will be like the chords of a circle having a radius equal to AE and EF. If a number of these sets of T-tool 90s are drawn at different radii and corresponding points E are marked, the path of each loci curve 22 of the E's off the line AB can be marked and can be joined to represent the loci curves 22 arising off line AB. The greater the number of the E points related to a particular loci curve 22, the more accurate the loci curve 22 is depending on the number of different radii of T-tool 90 sets used. By using equations for the loci curves 22, accuracy can be increased almost to perfect in many ways, for example, assistance from a computer for digitally drawing the loci curves 22.

If two transparent or translucent sheets 20, 30 are made indicating the loci curves 22, 32, where one of the sheets is a mirror image of the other (or reversed) and the two sheets are pivoted relative to each other at point A and positioned with line AB of one sheet placed on one arm of the angle and the other line AB of the other sheet, and the angle A placed on the vertex of the angle, the loci curves 22, 32 will intersect at positions of angle divisions which define a diamond-like quadrant with progressive divisions in order 1, 2, 3, 4 etc outwardly from the vertex of the angle.

Different sets of T-tool 90s advance which advance the point E's for drawing loci curves 22, 32.

Referring to FIG. 9, Euclid's Postulates involve straight lines and points. The present invention provides a tool, referred to as the T-tool 90, that has two points E, F joined by a straight line 91 of a fixed length and a bisecting line 92 that bisects points E, F at a right angle. Essentially, a T-tool 90 is two straight lines intersecting at 90 degrees. The bisecting line 92 of a T-tool 90 always is aligned such that passes through vertex A of an angle to be divided. If the points E,F of the T-tool 90 are placed on any angle to be divided and the bisecting line 92 of the T-tool 90 is made to pass through the vertex of the angle, and the bisecting line 92 will bisect the angle: acute or obtuse. A T-tool 90 can be made of any size that can geometrically fit and be used for any angle to be divided on a transparent film or plastic material. The film or plastic material may have holes corresponding to points E,F and the bisecting line 92 is visually marked. The T-tool 90 can be used to bisect an angle UVW, where V is the vertex of the angle.

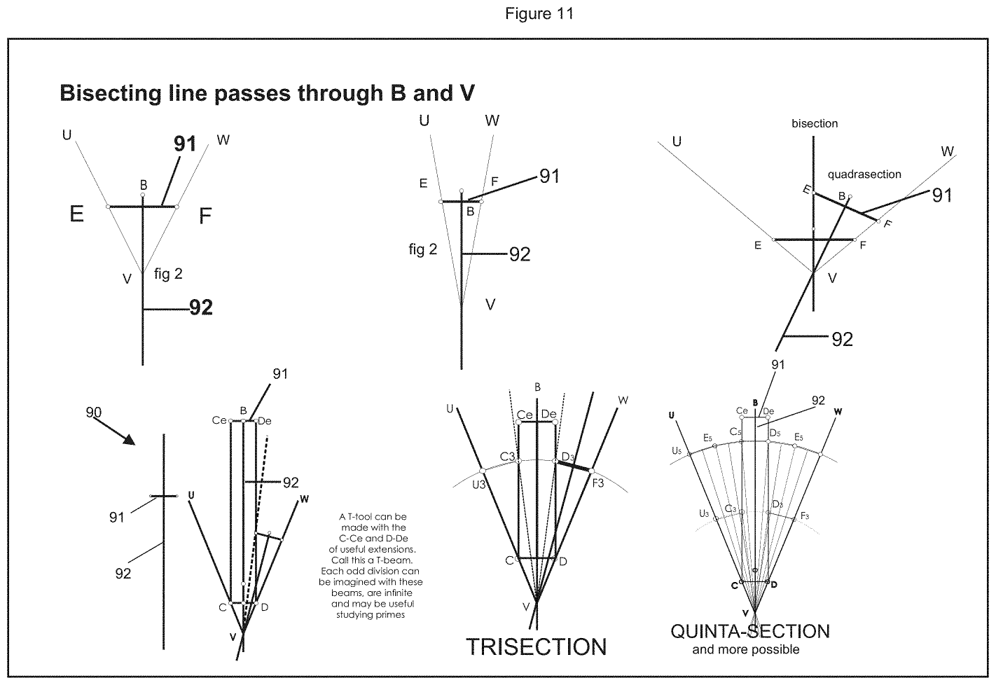

Referring to FIG. 11, after a T-tool 90 is made it can be used many times to divide angles. A T-tool 90 of a suitable size is selected. The length of the line 91 between E, F must be identical for T-tool 90s used in multiple division. An angle is bisected as described above and points E,F are marked on the paper which where the marked points on the paper are C, D. The T-tool 90 is moved with its bisecting line 92 on the angle's bisection line, and points Ce and De are marked. Lines C-Ce and D-De are drawn. The centre chord of any odd sectioning of an angle can fit exactly into this area at a fixed radius of an arc. The T-tool 90 is moved between D-De and DW with its bisecting line 92 through V until point E is on the line D-De and point F is on the line VW. Point E is marked and labelled D3 and point F is marked and labelled F3. An arc is drawn connecting points D3 and F3 or the T-tool 90 is placed for C3 and the angle is trisected.

Asymptotes are the straight lines drawn in from points at infinity where points E, F of T-tool 90s align at infinity off line AB (the line placed against the arm of an angle). The area between adjacent asymptotes is referred to as an asymptote area 61, 71. The first T-tool 90 has its point F aligned against the line AB and rotated relative from vertex A with the bisecting line 92 of the T-tool 90 always passing through vertex A (which later is placed on the vertex A of the angle). Point E is for drawing out a line of a first loci curve 22 off line AB. Point F of a second T-tool 90 also follows with its bisecting line 92 also passing through vertex A and its point E is for drawing out a second loci curve 22 off line AB. A third T-tool 90 has its point F aligned on point E of the previous second T-tool 90 along its loci curve 22, and point E of the third T-tool 90 is for drawing out a third loci curve 22 and so on.

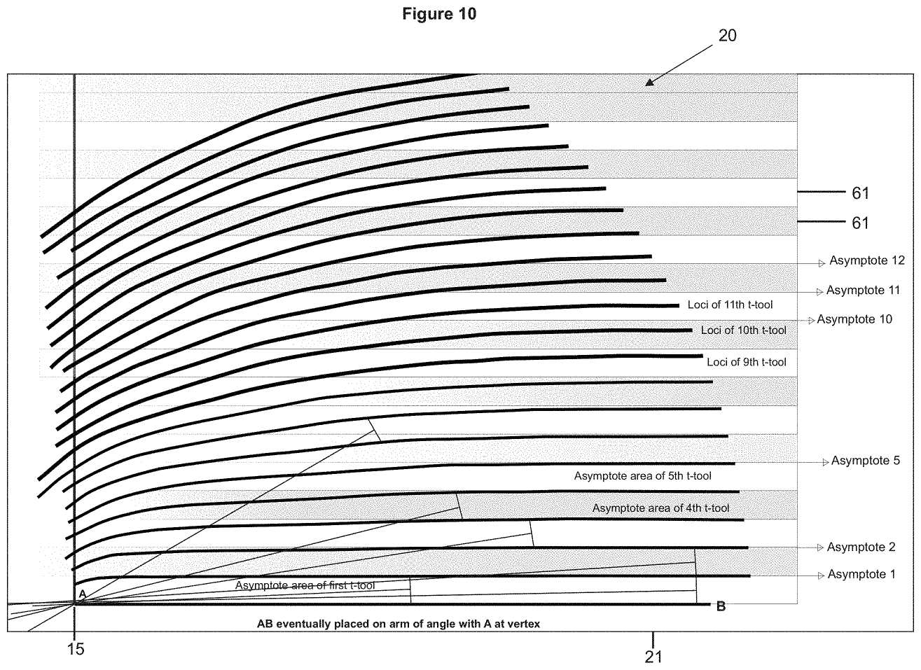

Referring to FIGS. 4 and 10, progressive loci curves of E points of a T-tool 90 advance progressively towards their asymptotes that are all parallel to the line AB of dimension EF off the previous asymptote.

With any circle or arc, the E and F points of a T-tool 90 of an appropriate size can be positioned and by marking points of bisection, a bisecting line can be drawn that will pass through the centre of the circle, and by doing this twice, the centre of the circle or arc will be found.

Every angle can have an arc with its centre along the bisecting line to pass through E and F points of the T-tool 90. If these angles are divided by trisection or by a larger number through calculation, they will intersect at definite points on each arc and loci of trisection or other loci which can be drawn out unique to the length of the line between E and F. A T-tool can be made with holes at E, F and slots to correspond to the loci of trisection or other loci. When the T-tool 90 is positioned on any angle drawn on paper, E, F is marked and loci drawn on the paper. When arcs are drawn through E, F with the centre at the vertex of the angle points of intersection will mark points of, for example, trisection of the angle. With 180 degrees and angles first bisect and then trisect each half to actually divide the angle by six, every second one, a point of the division.

All that is required is a T-tool 90 and with loci for trisection is able to be presented. The T-tool 90 can made of a transparent plastic material with through holes at points E,F and slots to draw the loci. When arcs with centre at vertex pass through E,F, there will be intersection points for division of the angle. The T-tool 90 can draw the arc if a point can be passed through its bisecting line 92 at the vertex and drawing a point through a hole at E or F is used to draw the arc or loci.

A T-tool 90 is placed on an angle UVW with V as the vertex. Angle UVW is bisected and points C and D are marked corresponding to E, F of the T-tool 90. The T-tool 90 is moved up along the bisecting line of the angle, and additional points can be marked corresponding to E, F again, as labelled points Ce and De. If lines are drawn through Ce and C, and De and D, a parallel beam will bisect the angle. If the T-tool 90 is placed with its bisecting line 92 through the vertex of the angle, the E of the T-tool 90 is on De and the F of the T-tool 90 is on VW, the angle will be trisected by the T-tool 90 where E meets DDe. This point is marked and the T-tool 90 is positioned again on the bisecting line in the central bream with point F of the T-tool 90 for a first point of trisection along De and marking point CCe corresponding to point E of the T-tool 90 for a second point of trisection. An arc with its centre at V passing through the initial point of trisection will pass through other points of trisection on CCe.

Referring to FIG. 11, the line EF of the T-tool 90 is like a chord and all odd division of an angle using chords will have its central chord along the central bream. After trisection two T-tools 90 can move on with their bisectors through the vertex of the angle to be divided. One T-tool 90 will have its point F moving along VW and the other with its point E along DDe. Points F off DDe and E off VW coincide where their points of intersection of quinta-section can be marked. Any use of T-tools 90 for a sheet 20, 30 of the device 10 requires that all the T-tools have the same length for line EF.

Consider an angle UVW with V as its vertex. Any arc with its centre at V along the length of its arm has a chord which is a major chord. Any arc is a division of a circle and its major chord is a fixed size relating to radius. Any multiplication of its radius multiplies the length of the arc and chord by the same amount. As T-tools 90 are positioned for division, the E, F points of the T-tool 90 of some are locked and travel along straight lines VU, VW and along CCe and DDe with a straight line asymptote for the corresponding E and F points of the T-tool 90. All other E and F points travel along loci curves 22 but each of these E and F points arise from the lines VU and VW. However, these have definite asymptote points at infinity which can be imagined and drawn back parallel from these points parallel to VW, VU, CCe and DDe. This helps explain the progression of T-tools 90 when dividing angles and helps position the T-tools 90. As the F point of the T-tool 90 that travels along line VW gradually the chord EF becomes more perpendicular to line VW. This draws in the radius of the arc related to angle division and its major chord's growth. There is a curved line of bisection which arises. Arcs can be drawn related to the intersections of asymptotes.

The number of T-tools 90 in an arc equals to the number of progressions out from the vertex and T-tools 90 restricts arc growth so each advance is progressively less with smaller radius increase and distance between chord and arc shrinkage. For simplicity, circles with a diameter the same as the chord of the T-tool 90 are used to represent the T-tools 90. Asymptotes are related to T-tool progression. Paths of some E and F points of the T-tool 90 are fixed straight lines that travel with a first asymptote such as the central T-tool having its E point fixed along line CCe and its F point fixed along line DDe and the F point of another T-tool 90 is fixed along line VW as it progresses as does the E point along line VU. When T-tools 90 align there is a division of an angle.

In some embodiments, equally sized circles just touching each other can be used instead of T-tools.

Although a T-tool 90 has been described as a “T”, other forms are possible that incorporate the basic “T”, include rectangular box at the intersection of EF with the bisecting line or a diamond or circle.

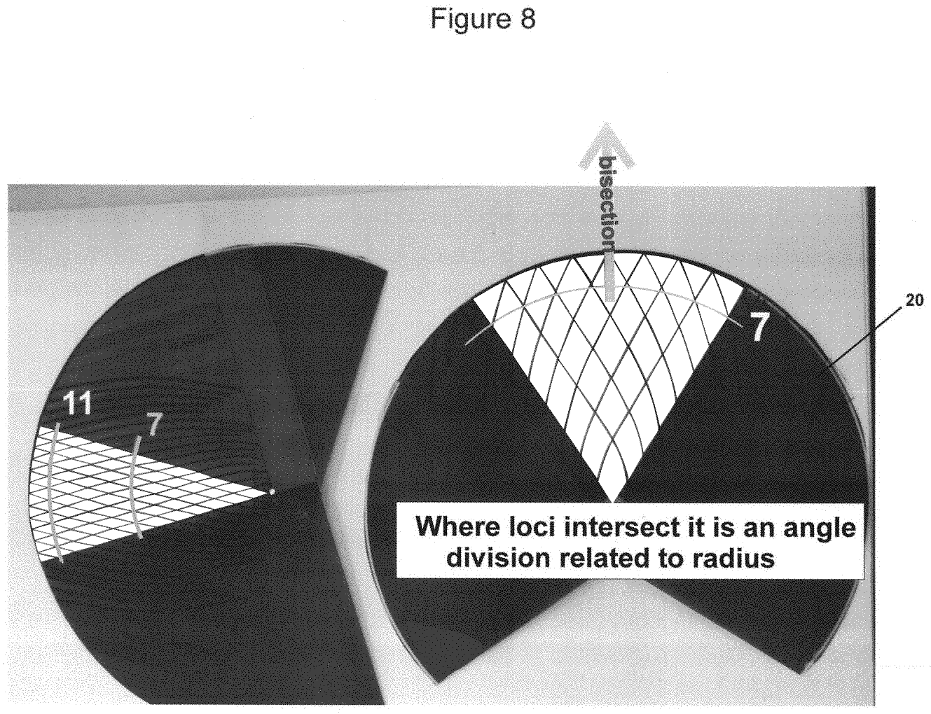

Referring to FIG. 8, although rectangular sheets 20, 30 have been described, other shapes for the sheets 20, 30 are possible such as semi-circles.

Unless specified to the contrary, any and all components herein described are understood to be capable of being manufactured and, as such, may be manufactured together or separately.

Moreover, in interpreting the disclosure, all terms should be interpreted in the broadest reasonable manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A device for dividing an angle into a plurality of smaller equal angles, comprising:
a lower translucent sheet; and
an upper translucent sheet positioned over the lower translucent sheet and pivotally connected to the lower translucent sheet at a pivot point for alignment to a vertex of the angle, to enable the upper translucent sheet to rotate relative to the lower translucent sheet;
wherein the translucent sheets are marked with visual indicia corresponding to:
a straight arm line for alignment on an arm of the angle; and
a plurality of progressive loci curves using a T-tool defined by a straight line (EF) of a fixed length between two points (E, F) that is bisected by a bisecting straight line (B) at 90 degrees, each loci curve is formed by marking a point corresponding to a position at point E of the T-tool when the bisecting straight line (B) passes through the vertex of the angle, and point F of the T-tool is initially positioned on the straight arm line or positioned on a previous point E of the T-tool for a previous loci curve.

2. The device according to claim 1, wherein the translucent sheets further comprise visual indicia corresponding to a plurality of arcs having a centre corresponding to the pivot point.

3. The device according to claim 2, wherein the translucent sheets further comprise visual indicia corresponding to a plurality of asymptote areas, each asymptote area having the same height corresponding to the fixed length of the straight line (EF) and arranged parallel to the straight arm line.

4. The device according to claim 1, wherein the translucent sheets are transparent.

5. The device according to claim 3, wherein the sheets are made from a flexible or rigid material.

6. The device according to claim 3, wherein the sheets comprise holes or slots to permit a writing instrument to mark a writing medium depicting the angle, positioned beneath the lower translucent sheet.

7. The device according to claim 3, wherein each said asymptote area is a different colour, shading or pattern, and the asymptote areas of both sheets are the same.

8. A method for dividing an angle into n number of smaller equal angles using the device according to claim 1, comprising:
positioning the lower translucent sheet such that the straight arm line of the lower translucent sheet is aligned with a first arm of the angle;
positioning the upper translucent sheet such that the straight arm line of the upper translucent sheet is aligned with a second arm of the angle; and
positioning the pivot point over the vertex of the angle;
wherein n number of quadrilateral areas are defined by intersections of loci curves of the upper translucent sheet with loci curves on the lower translucent sheet between the straight arms lines of the translucent sheets, and n−1 intersection points of the intersecting loci curves of the n number of quadrilateral areas distal to the pivot point are marked.

9. The method according to claim 8, further comprising drawing angle dividing straight lines between the vertex of the angle and the marked n−1 intersection points.

10. The device according to claim 3, wherein the translucent sheets are made from a flexible or rigid material.

11. The device according to claim 4, wherein each said asymptote area on the transparent sheets is a different colour, shading or pattern, and the asymptote areas of both sheets are the same.

12. The device according to claim 4, wherein the transparent sheets comprise holes or slots to permit a writing instrument to mark a writing medium depicting the angle, positioned beneath the lower transparent sheet.

13. A method for dividing an angle into n number of smaller equal angles using the device according to claim 1, the method comprising:
positioning the lower translucent sheet such that the straight arm line of the lower translucent sheet is aligned with a first arm of the angle;
positioning the upper translucent sheet such that the straight arm line of the upper translucent sheet is aligned with a second arm of the angle; and
positioning the pivot point over the vertex of the angle;
wherein n number of quadrilateral areas are defined by intersections of loci curves of the upper translucent sheet with loci curves on the lower translucent sheet between the straight arms lines of the translucent sheets, and n−1 intersection points of the intersecting loci curves of the n number of quadrilateral areas distal to the pivot point are marked.

14. A method for dividing an angle into n number of smaller equal angles using the device according to claim 1, the method comprising:
positioning the lower translucent sheet such that the straight arm line of the lower translucent sheet is aligned with a first arm of the angle;
positioning the upper translucent sheet such that the straight arm line of the upper translucent sheet is aligned with a second arm of the angle; and
positioning the pivot point over the vertex of the angle;
wherein n number of quadrilateral areas are defined by intersections of loci curves of the upper translucent sheet with loci curves on the lower translucent sheet between the straight arms lines of the translucent sheets, and n−1 intersection points of the intersecting loci curves of the n number of quadrilateral areas distal to the pivot point are marked.
